(19) United States
(12) Patent Application Publication
(10) Pub. No.: US 2015/0074130 A1
(43) Pub. Date: Mar. 12, 2015

(54) METHOD AND SYSTEM FOR REDUCING DATA DIMENSIONALITY

(71) Applicant: Technion Research & Development Foundation Limited, Haifa (IL)

(72) Inventors: Ron KIMMEL, Haifa (IL); Yonathan Aflalo, Tel-Aviv (IL)

(21) Appl. No.: 14/480,720

(22) Filed: Sep. 9, 2014

Related U.S. Application Data
(60) Provisional application No. 61/875,396, filed on Sep. 9, 2013.

(51) Int. Cl. G06F 17/30

(52) U.S. Cl. CPC G06F 17/30595
USPC 707/756

(57) ABSTRACT

A method of reducing a dimensionality of a dataset is disclosed. The method comprises: calculating an interpolation matrix based on a Laplacian eigenbasis matrix of a sparse representation of the dataset; applying multidimensional scaling (MDS) to a transformation matrix of the interpolation matrix, thereby providing a reduced dataset; and storing the reduced dataset is a computer readable medium.

### RELATED APPLICATION

This application claims the benefit of priority under 35 USC §119(e) of U.S. Provisional Patent Application No. 61/875,396 filed on Sep. 9, 2013, the contents of which are incorporated herein by reference in their entirety

### FIELD AND BACKGROUND OF THE INVENTION

The present invention, in some embodiments thereof, relates to data processing and, more particularly, but not exclusively, to a method and system for reducing dimensionality of data.

Many computer applications are used to extract information from large amounts of data. For example, computer applications are employed to extract useful trends and correlations from large databases of raw data. It may involve consolidating and summarizing huge databases containing many items and making data viewable along multidimensional axes, while allowing the variables of interest to be changed at will in an interactive fashion.

Typically, a multidimensional database stores and organizes data in a way that better reflects how a user would want to view the data than is possible in a two-dimensional spreadsheet or relational database file. Multidimensional databases are generally better suited to handle applications with large volumes of numeric data and that require calculations on numeric data, although they are not limited to such applications.

A dimension within multidimensional data is typically a basic categorical definition of data, each dimension may have a hierarchy associated with it, and each hierarchy may have any number of levels.

Dimensionality reduction is a known data processing technique, in which a dataset is simplified by scaling down its dimensions. Dimensionality reduction is particularly useful for the purpose of recognition and classification. The efficiency of dimension reduction tools is typically measured in terms of the required computational resources, which generally depend on the number of data points in the dataset. Dimensions-reduction typically involves a tradeoff between sparse local operators that involve less than quadratic complexity, and multi-scale models with quadratic complexity.

One family of dimensionality reduction is known as multidimensional scaling (MDS) that attempts to map all pairwise distances between data points into small dimension Euclidean domains. MDS can be used as a technique for storing data to elements as a relative set of points in a space having reduced dimensionality with respect to the size of the set. The relative location of the pints is dependent upon the element similarities or dissimilarities, which are interpreted as a set of distances between the points.

For example, U.S. Pat. No. 6,569,096 discloses an MDS technique in which sets of observable samples are generated, where each observable sample is generated by a different algorithm combining a number of factors. Data on observable relative differences between samples are collected for each set, and multidimensional statistical analysis is performed on the collected data. U.S. Pat. No. 8,645,440 discloses an MDS technique in which an iterative optimization technique and a vector extrapolation technique are sequentially and repeatedly applied on a vector of coordinates which represents the coordinates of data elements of the dataset. U.S. Pat. No. 7,496,597 discloses a technique for representing an MDS space as a hierarchical data structure with root nodes and leaf nodes.

### SUMMARY OF THE INVENTION

According to an aspect of some embodiments of the present invention there is provided a method of reducing a dimensionality of a dataset. The method comprises: calculating an interpolation matrix based on a Laplacian eigenbasis matrix of a sparse representation of the dataset; applying multidimensional scaling (MDS) to a transformation matrix of the interpolation matrix, thereby providing a reduced dataset; and storing the reduced dataset is a computer readable medium.

According to some embodiments of the invention the method further comprises obtaining a kernel function for defining diffusion distances over the sparse representation, wherein the calculation of the interpolation matrix is based on the kernel function but not on the diffusion distances.

According to some embodiments of the invention the sparse representation of the dataset is characterized by a dissimilarity matrix, wherein the calculation of the interpolation matrix is also based on the dissimilarity matrix.

According to some embodiments of the invention the method further comprising calculating the dissimilarity matrix.

According to some embodiments of the invention the invention the method comprises selecting a subset of elements from the dataset, thereby providing the sparse to representation.

According to some embodiments of the invention the method the selection of the subset is by a farthest-point sampling procedure.

According to some embodiments of the invention the method comprises calculating the Laplacian eigenbasis matrix.

According to some embodiments of the invention the calculation of the dissimilarity matrix comprises calculating a dissimilarity measure between every two elements of the selected subset.

According to some embodiments of the invention the dissimilarity measure comprises a geodesic distance over a manifold defined by the dataset. According to some embodiments of the invention the calculation of the interpolation matrix comprises applying an optimization procedure to traces of matrices obtained by transformations of an eigenvalue matrix of the Laplacian eigenbasis by the interpolation matrix.

According to some embodiments of the invention the calculation of the interpolation matrix comprises transforming a matrix describing the sparse representation using a matrix constructed from the Laplacian eigenbasis matrix, from an eigenvalue matrix of the Laplacian eigenbasis, and from a projection matrix describing a projection of the dataset on the sparse representation.

According to some embodiments of the invention the transformation matrix of the interpolation matrix is a matrix defined as a transformation of the interpolation matrix using the Laplacian eigenbasis matrix.

According to some embodiments of the invention According to some embodiments of the invention the MDS is effected by a singular value decomposition procedure followed by an eigen decomposition procedure.

According to some embodiments of the invention the dataset comprises coordinates describing a plurality of objects.

According to some embodiments of the invention the dataset comprises images of handwritten characters or symbols.

According to some embodiments of the invention the dataset comprises biometric data.

According to some embodiments of the invention the dataset comprises audio data.

According to some embodiments of the invention the dataset comprises video data.

According to some embodiments of the invention the dataset comprises biological data.

According to some embodiments of the invention the dataset comprises chemical data.

According to some embodiments of the invention the dataset describes signals acquired by a medical device.

According to some embodiments of the invention the dataset comprises meteorological data.

According to some embodiments of the invention the dataset comprises seismic data.

According to some embodiments of the invention the dataset comprises hyperspectral data.

According to some embodiments of the invention the dataset comprises financial data.

According to some embodiments of the invention the dataset comprises marketing data.

According to some embodiments of the invention the dataset comprises textual corpus.

According to an aspect of some embodiments of the present invention there is provided a computer software product, comprising a computer-readable medium in which program instructions are stored, which instructions, when read by a data processor, cause the data processor to access a dataset execute the method as described above and optionally further detailed hereinbelow.

According to an aspect of some embodiments of the present invention there is provided a system of reducing a dimensionality of a dataset. The system comprises a data processor configured for accessing the dataset, calculating an interpolation matrix based on a Laplacian eigenbasis matrix of a sparse representation of the dataset, and applying multidimensional scaling (MDS) to a transformation matrix of the interpolation matrix.

According to some embodiments of the invention the data processor is configured for receiving a kernel function for defining diffusion distances over the sparse representation, wherein the calculation of the interpolation matrix is based on the kernel function but not on the diffusion distances.

According to some embodiments of the invention the sparse representation of the dataset is characterized by a dissimilarity matrix, and wherein the data processor is configured for calculating the interpolation matrix also based on the dissimilarity matrix.

According to some embodiments of the invention the system wherein the data processor is configured for calculating the dissimilarity matrix. According to some embodiments of the invention the data processor is configured for selecting a subset of elements from the dataset, thereby providing the sparse representation.

According to some embodiments of the invention the system wherein the data processor is configured for selecting the subset by employing a farthest-point sampling procedure.

According to some embodiments of the invention the data processor is configured for calculating the Laplacian eigenbasis matrix.

According to some embodiments of the invention the data processor is configured for calculating the dissimilarity matrix comprises by calculating a dissimilarity measure between every two elements of the selected subset.

According to some embodiments of the invention the dissimilarity measure comprises a geodesic distance over a manifold defined by the dataset.

According to some embodiments of the invention the data processor is configured for calculating the interpolation matrix by applying an optimization procedure to traces of matrices obtained by transformations of an eigenvalue matrix of the Laplacian eigenbasis by the interpolation matrix.

According to some embodiments of the invention the data processor is configured for calculating the interpolation matrix by transforming a matrix describing the sparse representation using a matrix constructed from the Laplacian eigenbasis matrix, from an eigenvalue matrix of the Laplacian eigenbasis, and from a projection matrix describing a projection of the dataset on the sparse representation.

According to some embodiments of the invention the transformation matrix of the interpolation matrix is a matrix defined as a transformation of the interpolation matrix using the Laplacian eigenbasis matrix.

According to some embodiments of the invention the MDS is effected by a singular value decomposition procedure followed by an eigen decomposition procedure.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for reducing a dimensionality of a dataset, according to some embodiments of the present invention;

FIG. 2 is a schematic illustration of a portion of a triangle mesh;

FIG. 3 is a schematic illustration of a data processing system, which can be used for reducing a dimensionality of a dataset, according to some embodiments of the present invention;

FIGS. 4A and 4B show shapes from the TOSCA database, and their corresponding canonical forms, as obtained in experiments performed according to some embodiments of the present invention;

FIGS. 5A and 5B show canonical forms of two shapes, as obtained in experiments performed according to some embodiments of the present invention;

FIG. 6 shows a comparison between a dimensionality reduction according to some embodiments of the invention, as compared with conventional MDS;

FIG. 7A shows relative geodesic distortion as a function of the number of sample points used in an interpolation procedure employed according to some embodiments of the present invention;

FIG. 7B shows geodesic error as a function of the number of vertices on a sphere, as obtained in an interpolation procedure performed according to some embodiments of the present invention; and

FIG. 8 shows embedding of 5,851 images of handwritten digit 8 into a plane, as obtained in experiments performed according to some embodiments of the present invention.

### DESCRIPTION OF SPECIFIC EMBODIMENTS OF THE INVENTION

The present invention, in some embodiments thereof, relates to data processing and, more particularly, but not exclusively, to a method and system for reducing dimensionality of data.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present inventors discovered that a dimensionality of a dataset can be efficiently reduced by considering the geometrical properties of the dataset. Specifically, the present inventors found that it is advantage to consider a dataset of elements as a sampled version of a manifold, e.g., a Riemannian 2-manifold, and reducing the dimensionality of the dataset by utilizing the geometry of the manifold.

Some of the operations for reducing the dimensionality of a dataset are matrix operations. Representative examples of operations include summation, multiplication, decomposition, transformation, and calculations of eigenvectors and eigenvalues. All these operations are well known to those skilled in the art of matrix operations. Herein, matrices are represented by bold letters.

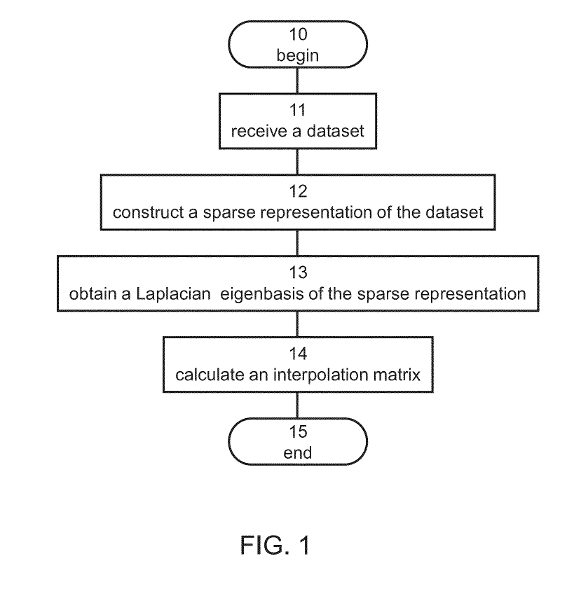

FIG. 1 is a flowchart diagram of a method suitable for reducing a dimensionality of a dataset, according to some embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method can be embodied in many forms. For example, it can be embodied in on a tangible medium such as a computer for performing the method steps. It can to be embodied on a computer readable medium, preferably a non-volatile computer readable medium, comprising computer readable instructions for carrying out the method steps. In can also be embodied in electronic device having digital computer capabilities arranged to run the computer program on the tangible medium or execute the instruction on a computer readable medium.

Computer programs implementing the method of the present embodiments can commonly be distributed to users over a communication network, such as the internet, or on a distribution medium such as, but not limited to, a CD-ROM or a flash drive. From the communication network or distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of the present embodiments. All these operations are well-known to those skilled in the art of computer systems.

The method begins at 10 and continues to 11 at which a dataset is received. The dataset is typically composed of a set [symbol] of n elements {V₁, V₂, . . . Vₙ}, wherein each element is a multidimensional dimensional element. The number of dimensions of each element is denoted dim. The elements of the dataset can represent any type of data, including, without limitation, coordinates describing a plurality of objects (e.g., CAD data, biological surfaces), audio data, video data, biological data (e.g., protein expression data, genomic data), chemical data (e.g., chemical structures, chemical properties), biometric data, signals acquired by a medical device (e.g., EEG data, MEG data, MRI data), meteorological data, seismic data, hyperspectral data, financial data, marketing data, textual corpus, images of handwritten characters or symbols and the like.

The elements of the dataset optionally and preferably sample a manifold, preferably a Riemannian 2-manifold, and can therefore be considered as points on the manifold. For example, when the elements of the dataset represent coordinates describing an object, the manifold can be the surface of the object. It is appreciated that a manifold, particularly a Riemannian 2-manifold, can also be defined for the aforementioned types of data even if the elements of the dataset are not coordinates on a surface of an object.

The metric tensor of the manifold is denoted by the upper case letter G. G defines distances on the manifold, scalar products between vectors or vector fields that are tangential to the manifold, and scalar products between functions that are defined on the manifold. The determinant of the metric tensor G is denoted by the lower-case letter g, and the discretization matrix of the square root of g is denoted A. For example, when the manifold represents a triangulated surface, A can be a diagonal matrix whose Λᵢᵢ element is the sum of areas of all triangles that share the surface vertex i.

The method optionally and preferably continues to 12 at which a sparse representation of the data set is constructed. Alternatively, the method can receive the sparse representation as input from external source (e.g., user input). The sparse representation is defined over a subset of mₛ (mₛ<n) elements from the dataset, which subset can be selected by the method or it can be received as input from external source (e.g., user input). The selection of the subset (in embodiments in which such operation is employed) can be according to any sampling technique known in the art. In some embodiments of the present invention the sampling is by a procedure known as the farthest-point sampling procedure, which is described in Eldar et al., “The farthest point strategy for progressive image sampling,” IEEE Trans. Image Processing, 1997, 6(9):1305-1315, the contents of which are hereby incorporated by reference. This procedure is known to be 2-optimal in the sense of covering.

The sparse representation is characterized by a dissimilarity matrix D, which contains a dissimilarity measure between every two elements of the selected subset.

It is not necessary for the dissimilarity matrix D to be calculated. As will be explained below, it was found by the present inventors that the dimensionally of the dataset can be reduced without knowledge of the matrix elements of the matrix D. Yet, in some embodiments, the matrix D is used for the dimensionality reduction. In these embodiments, the matrix D can be calculated by the method or received as input.

Each matrix element of D represents a dissimilarity measure between two elements over of the subset. In some embodiments of the present invention the dissimilarity measure between two elements relates to a geodesic distance between the respective two points of the manifold. For example, the dissimilarity measure can be the square of the geodesic distance. The value of the geodesic distance between two points is the length of the minimal geodesic of the manifold which passes through the points.

The calculation of geodesic distance matrices is well known in the art. In some embodiments of the invention the calculation of D is performed using the fast marching method (FMM), found, e.g., in J. A. Sethian, “A fast marching level set method for monotonically advancing fronts,” Proc. Nat. Acad. Sci., 1996, 93(4): 1591 -1595; and R. Kimmel and J. A. Sethian “Computing geodesic on manifolds,” Proc. US National Academy of Science, 1998, 95:8431-8435, the contents of which are hereby incorporated by reference. FMM is an efficient numerical method to compute a first-order approximation of the geodesic distances. Given a set of points on the manifold a distance map from these points to other points on the manifold is obtained as the solution of an Eikonal equation.

In some embodiments of the present invention the dissimilarity measure between two elements relates to a diffusion distance between the respective two points on the manifold. The concept of diffusion distance is known in the art and found in Berard et al., 1994, “Embedding Riemannian manifolds by their heat kernel,” Geom Funct Anal 4(4):373-398, and Coifman et al., 2006 “Diffusion maps,” Appl Comput Harmon Anal 21(1):5-30, the contents of which are hereby incorporated by reference.

Generally, given a kernel function K(,) , the diffusion distance D between two points satisfies D₂(x,y)=Σₖ(φₖ(x)−φₖ(y))₂K(λₖ) where φₖ represents the kth eigenfunction of a Laplace operator (e.g., the Laplace-Beltrami operator) on the manifold, and λₖ is its associated eigenvalue. It was found by the present inventors that when the dissimilarity measure relates to the diffusion distance, it is sufficient to obtain the kernel function for reducing the dimensionally of the dataset, whereby the diffusion distance themselves (the individual matrix elements of the matrix D) are not required.

The method optionally continues to 13 at which a Laplacian eigenbasis of the sparse representation of the dataset is obtained. The Laplacian eigenbasis can be expressed as a Laplacian eigenbasis matrix Φ, whose ith column is the ith eigenfunction of the Laplace operator, where 1≦i i≦mₛ. The Laplacian eigenbasis can be calculated by the method or received as input from external source (e.g., user input).

In some embodiments of the present invention the columns of the Laplacian eigenbasis matrix Φ are eigenfunction of the Laplace-Beltrami operator (LBO). The LBO is defined over a non-planar surface, and is generally defined as the divergence to of the gradient of the surface. The LBO is typically expressed by means of a discretization matrix L. Typically, the diagonal of L is the negative sum of the off- diagonal elements of the corresponding row. Any discretization matrix can be used for constructing the Laplacian eigenbasis. In some embodiments of the present invention L satisfies the relation L=A⁻¹W, where W is a weight matrix.

In some embodiments, the weight matrix W is defined in terms of cotangent edge weights which are suitable for constructing a discrete LBO operator on a triangle mesh that discretized the manifold. Cotangent edge weights are weights that are assigned to the edges of the triangles of the meshes, and that are proportional to cotangents of angles between edges. The use of the cotangent function is particularly useful since it expresses the ratio between a scalar product and a vector product between two edges. Typically, an edge is assigned with a weight that is proportional to cotangents of angles between edges that share triangles with it. When an edge is on the boundary of the surface, it is associated with one angle and it can be assigned with a weight that is proportional to the cotangent of the angle against the edge at a vertex of the triangle opposite to the edge. When an edge is internal with respect to the boundary of the surface, it is associated with two triangles and it can be assigned with a weight that is proportional to the sum of cotangents of the angles against the edge at the vertices of the two triangles opposite to the edge.

A portion of a triangle mesh is illustrated in FIG. 2. An edge (ξ,η) is marked between two vertices ξ and η. The edge is illustrated as internal and is therefore shared by two triangles. In each triangle, there is a vertex that is opposite to edge (ξ,η). The angles against (ξ, η) at the two vertices opposite to (ξ, η) are denoted β_{ξη} and γ_{ξη}. Using these notations, the weight matrix W can be defined as:

$${W}_{ξη} = \{ \begin{matrix}{{\sum }_{τ}}_{( ξ , τ ) ∈ E} ( cot {γ}_{ξτ} + cot {β}_{{ξ}_{τ}} ) & if ξ = η \\ - ( cot {γ}_{ξη} + cot {β}_{ξη} ) & if ξ \neq η , ( ξ , η ) ∈ I\end{matrix} \qquad EQ . 1$$

where E is the set of edges of the triangle mesh.

In some embodiments, the weight matrix W is the graph Laplacian, where the graph is constructed by connecting nearest neighbors. Graph Laplacian matrices are known in the art and found, for example, in Belkin et al., 2001, “Laplacian eigenmaps and spectral techniques for embedding and clustering,” Advances in Neural Information Processing Systems (MIT Press, Cambridge, Mass.), pp 585-591, the contents of which are hereby incorporated by reference.

Once the discretization matrix L of the LBO is obtained, the eigenvectors of L can be calculated and the matrix Φ can be constructed by setting its ith column to be the ith eigenvector of.

The method continues to 14 at which an interpolation matrix α is calculated based on the Laplacian eigenbasis matrix Φ, and optionally also based on the dissimilarity matrix D. The calculation of α can be done in more than one way.

In some embodiments of the present invention an optimization procedure is applied to the traces of the matrices α^{T}Λα and αΛα^{T}, where Λ is an eigenvalue matrix of the Laplacian eigenbasis.

Herein, expressions of the form CRC^{T} and C^{T}RC where, C and R are some matrices, are referred to as “the transformation of the matrix R using the matrix C”.

Thus, the optimization procedure is applied to traces of matrices obtained by transformations of the matrix Λ by the matrix α. The optimization procedure is preferably subjected to the constraint (ΦαΦ^{T})ᵢⱼ=D(Vᵢ,Vⱼ). This optimization can be written as:

$${min}_{α ∈ ℝ {m}_{e} \times {m}_{e}} trace ( {α}^{T} Λα ) + trace ( {αΛα}^{T} ) + μ {\sum }_{( i , j ) ∈ ℐ} {‖ {( {ΦαΦ}^{T} )}_{ij} - D ( {V}_{i} , {V}_{j} ) ‖}_{F}^{2} , \qquad EQ . 2$$

where the summation is over the indices of the sparse representation, and the notation ∥·∥_{F} represent the Frobenius norm.

In some embodiments of the present invention α is calculated by transforming a matrix F describing the sparse representation using a matrix M, according to the relation α=MFM^{T}. The matrix F can be defined as Fᵢⱼ=F(Vᵢ,Vⱼ), where F is a function over the set of elements Vᵢ, and is defined for pairs of elements in the sparse representation. The matrix M is preferably constructed from several matrices, including the Laplacian eigenbasis matrix Φ, eigenvalue matrix Λ, and a projection matrix B describing a projection of the dataset on the sparse representation. A to preferred expression for the matrix M is M=2 μ(Λ+μΦ^{T}B^{T}BΦ)⁻¹Φ^{T}B^{T}, where μ is a predetermined regularity parameter. A typical value for μ is from about 0.1 to about 0.9. In experiments performed by the present inventor μ was selected to be 0.5.

In embodiments in which the dissimilarity measures relate to diffusion distances, α is optionally and preferably calculated according the relation α=−2K, where K is a diagonal matrix whose elements are calculated using the kernel function of the diffusion length, for example, Kₖₖ=K(λₖ).

The method preferably continues to 15 at which multidimensional scaling (MDS) is applied to a matrix \tilde{D} defined as a transformation matrix of α. Preferably, \tilde{D} is the transformation of α using Φ, e.g., \tilde{D}=ΦαΦ^{T}. Generally, the MDS is applied so as to provide a reduced dataset including n elements (corresponding to the n elements of the original dataset), wherein the dimension of each element is k<dim. This corresponds to the first k columns of the matrix

$$- \frac{1}{2} J \tilde{D} J ,$$

where J is defined as Jᵢⱼ=δᵢⱼ−1/n, δᵢⱼ being the Kronecker delta. It was nevertheless found by the present inventors that it is not necessary to calculate the matrix elements of \tilde{D} for the purpose of executing the MDS procedure, as will now be explained.

In some embodiments of the present invention the MDS is applied by performing a singular value decomposition (SVD) to the matrix

$$- \frac{1}{2} H {αH}^{T} ,$$

where H is a matrix defined as H=Φ^{T}αJΦ, and selecting a portion of the vectors obtained by the SVD. The number k of the selected vectors is preferably less than the dimension dim of the dataset.

In some embodiments of the present invention the MDS is effected by an SVD procedure followed by an eigen-decomposition procedure. The SVD procedure is preferably applied to the matrix JΦ so as to express this matrix as JΦ=SUV^{T}. The eigen-decomposition procedure is applied to the matrix UV^{T}αVU, so as to express this matrix as UV^{T}αVU=PΓP^{T}. Once the matrices S, P and Γ are calculated from the SVD and eigen decompositions, a matrix Q defined as Q=SP(Γ)^{1/2}, is calculated. The skilled person would appreciate that the matrix QQ^{T} satisfies the relation QQ^{T}=J\tilde{D}J^{T}, so that the MDS can be completed by calculating the first k columns of Q, where k is lower than the dimension dim of the dataset. The advantage of this to technique is that it at least partially overcomes potential distortions caused by ignoring high-frequency components.

It is expected that during the life of a patent maturing from this application many relevant MDS procedures will be developed and the scope of the term MDS procedure is intended to include all such new technologies a priori.

Once the MDS is completed, the reduced dataset can be stored in a computer readable medium, more preferably non-transitory computer readable medium.

The method ends at 15.

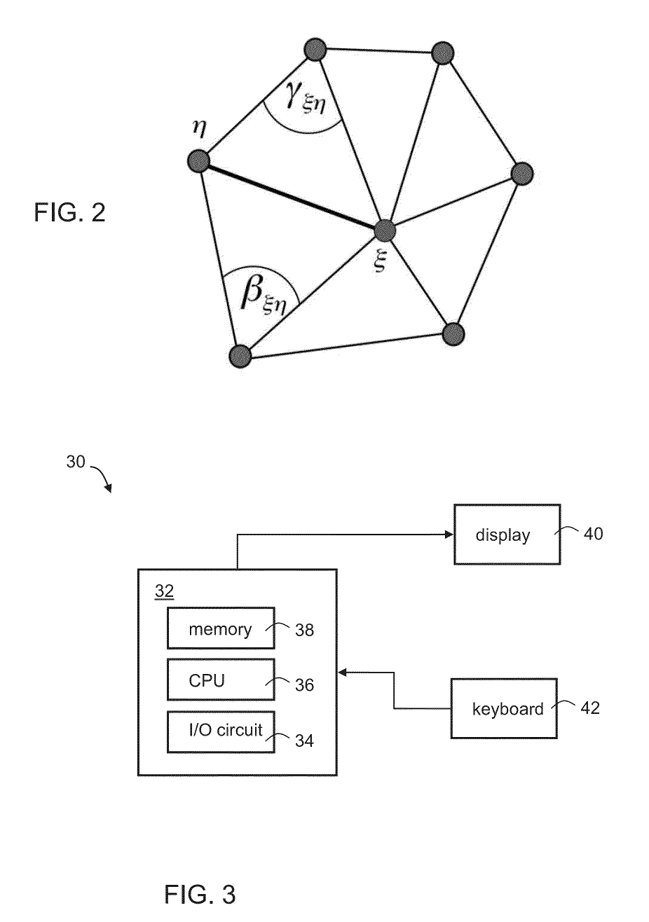

FIG. 3 is a schematic illustration of a data processing system 30 according to some embodiments of the present invention. System 30 comprises a computer 32, which typically comprises an input/output (I/O) circuit 34, a data processor, such as a central processing unit (CPU) 36 (e.g., a microprocessor), and a memory 46 which typically includes both volatile memory and non-volatile memory. I/O circuit 34 is used to communicate information in appropriately structured form to and from other CPU 36 and other devices or networks external to system 30. CPU 36 is in communication with I/O circuit 34 and memory 38. These elements are those typically found in most general purpose computers and are known per se.

A display device 40 is shown in communication with data processor 32, typically via I/O circuit 34. Data processor 32 issued to display device 40 graphical and/or textual output images generated by CPU 36. A keyboard 42 is also shown in communication with data processor 32, typically I/O circuit 34.

It will be appreciated by one of ordinary skill in the art that system 30 can be part of a larger system. For example, system 30 can also be in communication with a network, such as connected to a local area network (LAN), the Internet or a cloud computing resource of a cloud computing facility.

In some embodiments of the invention data processor 32 of system 30 is configured for accessing the dataset, calculating the interpolation matrix based on a Laplacian eigenbasis matrix of the sparse representation of the dataset, and applying the MDS procedure to a transformation matrix of the interpolation matrix, as further detailed hereinabove.

In some embodiments of the invention system 30 communicates with a cloud computing resource (not shown) of a cloud computing facility, wherein the cloud to computing resource accesses the dataset, calculates the interpolation matrix based on a Laplacian eigenbasis matrix of the sparse representation of the dataset, and applies the MDS procedure to a transformation matrix of the interpolation matrix, as further detailed hereinabove.

The method as described above can be implemented in computer software executed by system 30. For example, the software can be stored in of loaded to memory 38 and executed on CPU 36. Thus, some embodiments of the present invention comprise a computer software product which comprises a computer-readable medium, more preferably a non-transitory computer-readable medium, in which program instructions are stored. The instructions, when read by data processor 32, cause data processor 32 to access the dataset and execute the method as described above.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be to presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Manifold learning refers to the process of mapping given data into a simple low-dimensional domain that reveals properties of the data. When the target space is Euclidean, the procedure is also known as flattening. The flat embedding is usually a simplification process that aims to preserve, as much as possible, distances between data points in the original space, while being efficient to compute. One family of flattening techniques is multidimensional scaling (MDS), which attempts to map all pairwise distances between data points into small dimensional Euclidean domains. Review of MDS applications in psychophysics can be found in Ref. [12], which includes the computational realization that human color perception is 2D.

The geometry of given data points can be explored by computing all pairwise distances. Then, a flattening procedure attempts to keep the distance between all couples of corresponding points in the low dimensional Euclidean domain. Computing pairwise distances between points was addressed by extension of local distances on the data graph [1, 13], or by consistent numerical techniques for distance computation on surfaces [14]. The complexity involved in storing all pairwise distances is quadratic in the number of data points, which is a limiting factor in large databases.

Alternative models try to keep the size of the input as low as possible by limiting the input to distances of just nearby points. One such example is locally linear embedding [15], which attempts to map data points into a flat domain where each feature coordinate is a linear combination of the coordinates of its neighbors. The minimization, in this case, is for keeping the combination similar in the given data and the target a flat domain. Because only local distances are analyzed, the pairwise distances matrix is sparse, with an effective size of O(n), where n is the number of data points. Along the same line, the Hessian locally linear embedding [16] tries to better fit the local geometry of the data to the plane. Belkin and Niyogi [17] suggested embedding data points into the Laplace-Beltrami eigenspace for the purpose of data clustering. Only distances of nearby points by which an LBO is defined. The data can then be projected onto the first eigenvectors that correspond to the smallest eigenvalues of the LBO. The question of how to exploit the LBO decomposition to construct diffusion geometry was addressed in Ref. [18, 19].

De Silva and Tenenbaum [20] recognized the computational difficulty of dealing with a full matrix of pairwise distances, and proposed working with a subset of landmarks, which is used for interpolation in the embedded space. Bengio et al. [21] proposed to extend subsets by Nystrom extrapolation, within a space that is an empirical Hilbert space of functions obtained through kernels that represent probability distributions. However, they did not incorporate the geometry of the original data. Asano et al. [22] subdivided the problem into O(\sqrt{n}) subsets of O(\sqrt{n}) data points in each. It was found by the present Inventors that such a reduction may be feasible provided the distances between data points can be computed in constant time, which is seldom the case.

The computational complexity of multidimensional scaling was addressed by a multigrid approach in Ref. [23] and vector extrapolation techniques in Ref. [24]. In both cases the acceleration, although effective, required all pairwise distances, an O(n²) input. In Ref. [25], geodesics that are suspected to distort the embedding due to topology effects were filtered out in an attempt to reduce distortions. It was found by the present Inventors that while such filters eliminate some of the pairwise distances, it is not to the extent of substantial computational or memory savings, because the goal was mainly reduction of flattening distortions. In Ref. [26], the eigenfunctions of the LBO on a surface were interpolated into the volume bounded by the surface. This procedure was designed to overcome the need to evaluate the LBO inside the volume, as proposed in Ref. [27]. Both models deal with either surface or volume LBO decomposition of objects in [symbol] ^{3′} and were not designed to flatten and simplify structures in big data. Another dimensionality reduction method, is the principal component analysis method (PCA). The PCA procedure projects the points to a low-dimensional space by minimizing the least-square fitting error. In Ref. [28], that relation was investigated through kernel PCA.

The present Example exploits the property that the gradient magnitude of distance functions on the manifold is equal to 1 almost everywhere. It was found by the present Inventors that interpolation of such smooth functions can be efficiently obtained by projecting the distances into the LBO eigenspace. The present Inventors employed such interpolation and successfully reduced the complexity of the flattening procedure. The efficiency was established by considering a sparse represe3ntation of the pairwise distances that are projected onto the LBO leading eigenfunctions.

Broadly speaking, the differential structure of the manifold is captured by the eigenbasis of the LBO, whereas its multiscale structure is encapsulated by sparse sampling of the pairwise distances matrix. The present Example demonstrates this idea by extracting the [symbol] ⁴ structure of points in [symbol] ^{10,000} canonizing surfaces to cope with nonrigid deformations, and mapping images of handwritten digits to the plane. The technique of the present embodiments operates on data in any dimension.

A Riemannian manifold [symbol] having a metric G, is considered. The manifold and its metric induce a LBO, often denoted by Δ_{G}, and here, without loss of generality by Δ. The LBO is self-adjoint and defines a set of functions called eigenfunctions, denoted φᵢ, such that Δφᵢ=λᵢφᵢ and

∫_{M}φᵢ(x)φ_{\check{j}}(x)da(x)=δᵢⱼ,

where da is an area element. These functions have been used to construct descriptors [30] and linearly relate between metric spaces [31]. In particular, for problems involving functions defined on a triangulated surface, when the number of vertices of [symbol] is large, the dimensionality of the functional space can be reduced by considering smooth functions defined in a subspace spanned by just a couple of eigenfunctions of the associated LBO.

To prove the efficiency of LBO eigenfunctions in representing smooth functions, consider a smooth function ƒ.

As used herein the term “smooth,” in the context of a function ƒ, refers to a function having a gradient ∇_{G}ƒ whose L₂ norm ∥∇_{G}ƒ∥² is below a predetermined threshold. For a smoothest functional orthonormal basis, it is typically desired to find a finite basis of, say, n functions {φᵢ}, i=1, . . . , n, that approximate any given smooth function. Formally, for any given function ƒ on the manifold, such that ∥∇_{G}ƒ∥²<c, the desired set of basis functions {Φᵢ} allow to approximate f≈Σ [symbol] f,φᵢ [symbol] φᵢ, such that the representation error, defined by

$${r}_{n} = f - {\sum }_{1}^{n} 〈 f , {φ}_{i} 〉 {φ}_{i} ,$$

The present inventors found that for each i satisfying 1≦i≦n, each of the scalar products [symbol] rₙ, φᵢ [symbol] _{G} and [symbol] ∇_{G}rₙ, ∇_{G}φᵢ [symbol] _{G} equals zero. Using these properties, the norms of rₙ and its gradient are obtained:

$${‖ {r}_{n} ‖}_{G}^{2} = {‖ {\sum }_{i = n + 1}^{∞} 〈 {r}_{n} , {φ}_{i} 〉 G {φ}_{i} ‖}_{G}^{2} = {\sum }_{i = n + 1}^{∞} {〈 {r}_{n} , {φ}_{i} 〉}_{G}^{2} , \\ {‖ {∇}_{G} {r}_{n} ‖}_{G}^{2} = {‖ {\sum }_{i = n + 1}^{∞} {〈 {r}_{n} , {φ}_{i} 〉}_{G} {∇}_{G} {φ}_{i} ‖}_{G}^{2} \geq {λ}_{n + 1} {\sum }_{i = n + 1}^{∞} {〈 {r}_{n} , {φ}_{i} 〉}_{G}^{2} . \\ Thus , \\ \frac{{‖ {∇}_{G} {r}_{n} ‖}_{G}^{2}}{{‖ {r}_{n} ‖}_{G}^{2}} \geq {λ}_{n + 1} .$$

where ordered eigenvalues λ₁≦λ₂ . . . have been assumed.

Since [symbol] ∇_{G}rₙ, ∇_{G}φᵢ [symbol] _{G}=0, the square of the norm of the gradient off, ∥∇_{G}ƒ∥_{G}², can be written as:

$${‖ {∇}_{G} {r}_{n} + {\sum }_{i = 1}^{n} {〈 f , {φ}_{i} 〉}_{G} {∇}_{G} {φ}_{i} ‖}_{G}^{2} = {‖ {∇}_{G} {r}_{n} ‖}_{G}^{2} + {\sum }_{i = 1}^{n} {〈 f , {φ}_{i} 〉}_{G}^{2} {λ}_{i} .$$

It follows that

$${‖ {r}_{n} ‖}_{G}^{2} \leq \frac{{‖ {∇}_{G} {r}_{n} ‖}_{G}^{2}}{{λ}_{n + 1}} \leq \frac{{‖ {∇}_{G} f ‖}_{G}^{2}}{{λ}_{n + 1}} .$$

For d dimensional manifolds, the spectra has a linear behavior in n^{2/d}, that is, λₙ≈C₁n^{2/d} as n→∞. The residual function rₙ depends linearly on ∥∇_{G}ƒ∥ which is bounded by a constant. It follows that rₙ converges asymptotically to zero at a rate of O(n^{2/d}). This convergence depends on ∥∇_{G}ƒ∥_{G}², so that there ∃C₂ such that

$$∀ f : ℳ \to ℳ {‖ {r}_{n} ‖}_{G}^{2} \leq \frac{{C}_{2} {‖ {∇}_{G} f ‖}_{G}^{2}}{{n}^{\frac{2}{d}}} . \qquad EQ . A .1$$

A d dimensional manifold which is sampled at n points {Vᵢ} , and a subset [symbol] of {1, 2, . . . , n} such that | [symbol] |=mₛ≦n is now considered.

Given a smooth function ƒ defined on [symbol] ={Vⱼ, j∈ [symbol] }, it is desired to interpolate ƒ, and to construct a continuous function \tilde{ƒ} such that \tilde{ƒ}(Vᵢ)=ƒ(Vᵢ) for each j in [symbol] . One type of interpolation is linear interpolation. It is desired that the function \tilde{ƒ} be as smooth as possible in L₂ sense. The smoothness of a function is measured by:

Eₛₘₒₒₜₕ(ƒ)=∫_{M}∥∇ƒ∥₂²da.

The problem of smooth interpolation can be rewritten as:

$${min}_{h : ℳ \to ℝ} {{E}_{smooth} ( h )}_{s . t .} ∀ j ∈ 𝒥 , h ( {V}_{j} ) = f ( {V}_{j} ) .$$

Since the norm ∥∇h∥₂ satisfies:

∫_{M}∥∇h∥₂²da=∫_{M} [symbol] Δh, h [symbol] da

the interpolation problem can be then be written as:

$${min}_{h : ℳ \to ℝ} {\int }_{ℳ} 〈 Δ h , h 〉 d a s . t . h ( {V}_{j} ) = f ( {V}_{j} ) ∀ j ∈ 𝒥 . \qquad EQ . A .2$$

Any discretization matrix of the LBO can be used for the eigenspace construction. In the present example the LBO general form L=A⁻¹W is used, where A⁻¹ is a diagonal matrix whose entries are inversely proportional to the metric infinitesimal volume elements. One example is the cotangent weights approximation for triangulated surfaces. Another example is the generalized discrete LBO suggested in Ref. [17]. In the first case, W is a matrix in which each entry is zero if the two vertices indicated by the two matrix indices do not share a triangle's edge, or the sum of the cotangents of the angles supported by the edge connecting the corresponding vertices. In the latter case, W is the graph Laplacian, where the graph is constructed by connecting nearest neighbors. The diagonal of the Laplacian matrix is the negative sum of the off-diagonal elements of the corresponding row. In the triangulated surface case, A is a diagonal matrix in which the element Aᵢᵢ is proportional to the area of the triangles about the vertex Vᵢ. A similar normalization factor also applies in the general case.

A discrete version of the smooth interpolation EQ. A.2 can be rewritten as:

$${min}_{x} {x}^{T} Wx s . t . Bx = f , \qquad EQ . A .3$$

where B is the projection matrix on the space spanned by the vectors eⱼ, j∈ [symbol] , where eⱼ is the jth canonical basis vector, and ƒ now represents the sampled vector ƒ(V [symbol] ).

The spectral projection of ƒ to the set of eigenfunctions of the LBO {φᵢ }, i=1, . . . , mₑ is denoted \hat{ƒ}. \hat{ƒ} can be written as:

$$\hat{f} = {\sum }_{i = 1}^{{m}_{e}} 〈 f , {φ}_{i} 〉 {φ}_{i} ,$$

where Δƒᵢ=λᵢφᵢ. The matrix whose ith column is φᵢ is denoted D. Thus, \hat{ƒ} can be to written as \hat{ƒ}=Φα, where α is a vector such that αᵢ= [symbol] ƒ, φᵢ [symbol] . EQ. A.3 can now be approximated by:

$${min}_{α ∈ ℝ {m}_{e}} {α}^{T} {Φ}^{T} W Φα s . t . B Φα = f . \qquad EQ . A .4$$

It is recognized that the transformation Φ^{T}WΦ=Λ, where Λ is the diagonal matrix whose elements are the eigenvalues of L. Alternatively, the constraint can be incorporated as a penalty in a target function, and the problem can be rewritten as:

$${min}_{α ∈ ℝ {m}_{e}} ( {α}^{T} Λα + μ {‖ B Φα - f ‖}^{2} ) = {min}_{α ∈ ℝ {m}_{e}} ( {α}^{T} ( Λ + μ {Φ}^{T} {B}^{T} B Φ ) α + 2 μ {f}^{T} B Φα ) .$$

The solution to this problem is given by:

α=2 μ(Λ+μΦ^{T}B^{T}BΦ)⁻¹Φ^{T}B^{T}ƒ=Mƒ. EQ. A.5

It was found by the present inventors that the above interpolation expressions can be used to formulate a pairwise geodesics matrix in a compact and accurate manner. The smooth interpolation, EQ. A.2, for a pairwise distances function can be defined as follows.

Let I= [symbol] × [symbol] be the set of pairs of indices of data points, and F(Vᵢ,Vⱼ) a value defined for each pair of points (or vertices in the surface example) (Vᵢ,Vⱼ), where (i,j)∈I. The present inventors successfully interpolated the smooth function D: [symbol] × [symbol] → [symbol] , whose values are given at (Vᵢ,Vⱼ), (i,j)∈I, by D(Vᵢ,Vⱼ)=F(Vᵢ,Vⱼ) for each (i,j)∈I. For that goal, a smooth-energy measure for such functions is defined, as follows:

Eₛₘₒₒₜₕ(D)=∫∫_{M}∥∇ₓD(x,y)∥²+∥∇_{y}D(x, y)∥²da(x)da(y).

The smooth interpolation problem can be written as:

$${min}_{D : ℳ \times ℳ \to ℝ} {E}_{smooth} ( D ) \\ s . t . D ( {V}_{i} , {V}_{j} ) = F ( {V}_{i} , {V}_{j} ) ∀ ( i , j ) ∈ ℐ . \qquad EQ . A .6$$

Any matrix D defined such that Dᵢⱼ=D(Vᵢ,Vⱼ), satisfies the following relation:

$${\int }_{ℳ} {‖ {∇}_{x} D ( x , {y}_{j} ) ‖}^{2} d a ( x ) = {\int }_{ℳ} 〈 {Δ}_{x} D ( x , {y}_{j} ) , D ( x , {y}_{j} ) 〉 d a ( x ) \approx {D}_{n}^{T} {WD}_{j} = trace ( {WD}_{j} {D}_{j}^{T} ) ,$$

where Dⱼ^{T} represents the jth column of D.

Then,

$$\int {\int }_{ℳ} {‖ {∇}_{x} D ( x , y ) ‖}^{2} d a ( x ) d a ( y ) \approx {\sum }_{j} {A}_{jj} trace ( {WD}_{j} {D}_{j}^{T} ) = trace ( W {\sum }_{j} {D}_{j} {D}_{j}^{T} {A}_{jj} ) = trace ( {WDAD}^{T} ) .$$

A similar result applies to:

∫∫_{M}∥∇_{y}D(x, y)∥²da(x)da(y)

so that:

∫∫_{M}∥∇ₓD(x,y)∥²da(x)da(y)≈trace(D^{T}WDA) and

∫∫_{M}∥∇ₓD(x,y)∥²da(x)da(y)≈trace(DWD^{T}A). EQ. A.7

The smooth energy can be discretized for a matrix D by:

Eₛₘₒₒₜₕ(D)=trace(D^{T}WDA)+trace(DWD^{T}A). EQ. A.8

The spectral projection of D onto Φ, is given by:

$$\begin{matrix}\tilde{D} ( x , y ) = {\sum }_{i} 〈 D ( \cdot y ) , {φ}_{i} 〉 {φ}_{i} ( x ) \\ = {\sum }_{i = 1}^{n} {\sum }_{j = 1}^{n} {〈 〈 D ( u , v ) , {φ}_{i} ( u ) 〉 , {φ}_{j} ( v ) 〉}_{{α}_{ij}} {φ}_{j} ( y ) {φ}_{i} ( x ) ,\end{matrix}$$

where

αᵢⱼ=∫∫_{M×M}D(x,y)φᵢ(x)φⱼ(y)da(x)da(y).

In matrix notations:

D=ΦαΦ^{T}, EQ. A.9

where D is a matrix whose matrix elements are given by Dᵢⱼ=\tilde{D}(xᵢ,yⱼ).

Combining EQs. A.8 and A.9 the discrete smooth energy of the spectral projection of a function can be written as:

$$\begin{matrix}{\tilde{E}}_{smooth} ( D ) = trace ( {Φα}^{T} {Φ}^{T} W {ΦαΦ}^{T} A ) + \\ trace ( {ΦαΦ}^{T} W {Φα}^{T} {Φ}^{T} A ) \\ = trace ( {Φα}^{T} {ΛαΦ}^{T} A ) + \\ trace ( Φ αΛ {α}^{T} {Φ}^{T} A ) \\ = trace ( {α}^{T} Λα ΦAΦ ) + trace ( {αΛα}^{T} {Φ}^{T} A Φ ) \\ = trace ( {α}^{T} Λα ) + trace ( {αΛα}^{T} ) .\end{matrix} \qquad EQ . A .10$$

Using the spectral smooth representation introduced in EQ. A.9, the smooth spectral interpolation problem for a function from [symbol] × [symbol] to [symbol] as:

$${min}_{α ∈ ℝ {m}_{e} \times {m}_{e}} trace ( {α}^{T} Λα ) + trace ( {αΛα}^{T} ) \\ s . t . {( {ΦαΦ}^{T} )}_{ij} = D ( {V}_{i} , {V}_{j} ) , ∀ ( i , j ) ∈ ℐ . \qquad EQ . A .11$$

Expressing the constraint as a penalty function the following optimization problem can be defined:

$${min}_{α ∈ ℝ {m}_{e} \times {m}_{e}} trace ( {α}^{T} Λ α ) + trace ( {αΛα}^{T} ) + μ {\sum }_{( i , j ) ∈ ℐ} {‖ {( {ΦαΦ}^{T} )}_{ij} - D ( {V}_{i} , {V}_{j} ) ‖}_{F}^{2} , \qquad EQ . A .12$$

where ∥·∥_{F} represent the Frobenius norm, and mₑ the number of eigenfunctions. EQ. A.12 describes a minimization problem of a quadratic function of α. Representing α as an (mₑ²×1) vector α, the problem can be rewritten as a quadratic programming problem. Similarly to EQ. A.5, a matrix M that satisfies the relation α=MD can be found, where D is the row stack vector of the matrix D(Vᵢ,Vⱼ).

Another, more efficient but less accurate way to obtain an approximation of the matrix α is to compute

α=MFM^{T} EQ. A.13

where F is the matrix defined by F_{i,j}=F(Vᵢ,Vⱼ) and M is the matrix introduced in EQ. A.5. Notice that spectral projection is a natural choice for the spectral interpolation of distances because the eigenfunctions encode the manifold geometry, as do distance functions. Moreover, the eikonal equation, which models geodesic distance functions to on the manifold, is defined by ∥∇_{G}D∥=1. EQ. A.1, in this case, provides a clear asymptotic convergence rate by spectral projection of the function D, because ∥∇_{G}D∥ is a constant equal to 1.

Following is a description of an exemplified suitable procedure for reducing the dimension of a dataset, which procedure can be employed according to some embodiments of the present invention. For simplicity only classical scaling is considered, but other types of scaling can be similarly applied.

Given a metric space [symbol] , such as a manifold, having a metric D: [symbol] × [symbol] → [symbol] , and [symbol] ={V₁, . . . , Vₙ a finite set of elements of [symbol] , the multidimensional scaling of [symbol] in [symbol] ^{k} involves finding a set of points [symbol] ={X₁, . . . , Xₙ} in [symbol] ^{k} whose pairwise Euclidean distances dist(Xᵢ,Xⱼ)=|Xᵢ−Xⱼ∥² are as close to D(Vᵢ,Vⱼ) for all (i,j). For the MDS member known as classical scaling, such embedding can be realized by the following minimization procedure:

$${min}_{X} {‖ {X}^{T} X - \frac{1}{2} JDJ ‖}_{F}$$

where and Jᵢⱼ=δᵢⱼ−1/n. Classical scaling (see EQ. A.12) finds the first k singular vectors and corresponding singular values of the matrix

$$- \frac{1}{2} JDJ .$$

The classical scaling solver requires the computation of an (n×n) matrix of distances, which is a challenging task when dealing with more than, say, several thousands of data points. The quadratic size of the input data imposes severe time and space limitations.

The Present inventors successfully employed spectral interpolation to overcome these complexity limitations.

A subset of mₛ points, with indices [symbol] of the data is selected. For efficient covering of the data manifold, this set can be selected using the farthest-point sampling strategy, which is known to be 2-optimal in the sense of covering. The geodesic distances between every two points (Vi,Vj)∈ [symbol] × [symbol] , (i,j)∈I= [symbol] × [symbol] .

A Laplacian operator is then constructed from the local relations between data points. In the present example, the LBO is selected. Use of techniques other than Laplacian operators, such as the Finite Elements Method is also contemplated.

The LBO takes into consideration the differential geometry of the data manifold. The Laplacian's first mₑ eigenvectors are computed and are arranged in an to eigenbasis matrix denoted by Φ. The spectral interpolation matrix α is then extracted from the computed geodesic distances and the eigenbasis Φ, using EQs. A.12 or A.13.

The interpolated matrix distance \tilde{D} between every two points of [symbol] can be computed by \tilde{D}=ΦαΦ^{T}. It is noted that there is no need to compute this matrix explicitly. The choice of representation is advantageous from the reason that follows.

Denote by D_{y}: [symbol] → [symbol] ⁺ the geodesic distance function from a source point y to the rest of the point in the manifold. Geodesic distance functions are characterized by the eikonal equation |V_{G}D∥=1. This property can be used in the bound provided by EQ. A.1. Specifically,

∥∇_{G}D_{y}²∥²=∥2D_{y}∇_{y}∇_{G}D_{y}∥²≦4∥D_{y}∥².

Plugging this relation to EQ. A.1, the error of the squared geodesic distance function projected to the spectral basis is given by:

$$\frac{{‖ {r}_{n} ‖}_{G}^{2}}{{‖ D ‖}_{G}^{2}} \leq \frac{4 {C}_{2}}{{n}^{\frac{2}{d}}} ,$$

where ∥D∥_{G} is the diameter of the manifold. Thus, a bound on the relative projection error has been obtained, which bound depends only on Weyl's constant and the number of eigenvectors used in the reconstruction by projection.

The spectral MDS solution is given by

$${XX}^{T} = - \frac{1}{2} J \tilde{D} J .$$

This decomposition can be approximated using more than one technique.

In a first technique, the projection of X to the eigenbasis Φ is considered. This is equivalent to representing X by \tilde{X}=Φβ, to provides the equation

$${Φββ}^{T} Φ = - \frac{1}{2} J Φα {Φ}^{T} J .$$

Since Φ^{T}AΦ=Iₘ_{ₑ} the matrix β satisfies:

$${ββ}^{T} = - \frac{1}{2} {Φ}^{T} AJ {ΦαΦ}^{T} JA Φ = - \frac{1}{2} H α {H}^{T} , \qquad EQ . A .14$$

so that a singular value decomposition applied to the (mₑ×mₑ) matrix

$$- \frac{1}{2} H α {H}^{T}$$

can provides the columns of β.

In a second method, the following decompositions are applied. An SVD procedure is applied to the matrix JΦ so as to express this matrix as JΦ=SUV^{T}. An eigen-decomposition procedure is applied to the matrix UV^{T}αVU, so as to express this matrix as UV^{T}αVU=PΓP^{T}. Once the matrices S, P and Γ are calculated from the to decompositions, a matrix Q defined as Q=SP(Γ)^{1/2}, is calculated. QQ^{T} satisfies the relation QQ^{T}=J\tilde{D}J^{T}, so that the MDS can be completed by calculating the first k columns of Q. The advantage of the second technique is that it at least partially overcomes potential distortions caused by ignoring the high-frequency components.

Algorithm 1, below, is an exemplified algorithm, for reducing the dimensionality of the dataset.

### Algorithm 1

Require: A data manifold [symbol] densely sampled at n points, number of sub-sampled points mₛ, and number of eigenvectors mₑ.
   Select [symbol] , a subset of inₛ points sampled from [symbol] .
   Compute the matrix D of squared geodesic distances between every two points (pᵢ,pⱼ), i∈ [symbol] , j∈ [symbol] .
   Compute the matrices Φ and Λ, containing the first mₑ eigenvectors and eigenvalues of the LBO of [symbol] .
   Compute the matrix α according to EQ. A.12 or A.13.
   Compute the SVD decomposition of the (n×mₑ) matrix JΦ, such that JΦ=SUV^{T}.
   Compute the eigen-decomposition of the (mₑ×mₑ) matrix UV^{T}αVU, such that UV^{T}αVU=PΓP^{T}.
   Compute the matrix Q=SP(Γ)^{1/2} such that QQ^{T}=J\tilde{D}J^{T}
Return: The first k columns of the matrix Q. When the dissimilarity between elements in the dataset is given as a diffusion distance, it is not required to calculate the diffusion distances, as will now be explained.

Given a kernel function K(λ), the diffusion distance between two points (x,y)∈ [symbol] is defined as:

$${D}^{2} ( x , y ) = {\sum }_{k} {( {φ}_{k} ( x ) - {φ}_{k} ( y ) )}^{2} K ( {λ}_{k} ) , \qquad EQ . A .15$$

where φₖ represents the kth eigenfunction of Δ [symbol] , and λₖ its associated eigenvalue.

Note that Dᵢⱼ=D²(xᵢ,yᵢ). In a matrix form, EQ. A.15 reads:

$${D}_{ij} = {\sum }_{k = 1}^{{m}_{e}} {( {Φ}_{ik} - {Φ}_{jk} )}^{2} {K}_{kk} ,$$

where Φ represents the eigen-decomposition matrix of the LBO and K is a diagonal matrix such that Kₖₖ=K(λₖ).

Denoting by Ψ, a matrix such that Ψᵢⱼ=Φᵢⱼ², it follows that:

D=ΨK [symbol] ₘ_{ₑ} [symbol] ₙ^{T}+(ΨK [symbol] ₘ_{ₑ} [symbol] ₙ^{T})^{T}.

where [symbol] ₓ denotes a column vector with x elements, all of which being 1.

The dimensionality reduction of the present embodiments is now applied to D, which by itself defines a flat domain. Since [symbol] ₙ^{T}J=0, it follows that ΨK [symbol] ₘ_{ₑ} [symbol] ₙ^{T}J=0, so that matrix JDJ can be written as:

JDJ=−2JΦKΦ^{T}J=JΦ(−2K)Φ^{T}J.

Thus, when the dimensionality reduction technique of the present embodiments is applied to diffusion distances it is sufficient to set α=−2K, and the inventive dimensionality reduction can be directly applied without explicit computation of these distances. Moreover, using data-trained optimal diffusion kernels, as those introduced in Ref. [34], a discriminatively enhanced flat domain, can be obtained, which enhanced flat domain facilitates a robust and efficient classification between different classes as part of the construction of the flat target space.

### Numerical Experiments

The embedding of the intrinsic geometry of a shape into a Euclidean space is known as a canonical form. When the input to an MDS procedure is the set of geodesic distances between every two surface points, the output is such a form. These structures are invariant to isometric deformations of the shape. FIGS. 4A and 4B show shapes (left) from the TOSCA database [43] and their corresponding canonical forms (right) obtained according to some embodiments of the present invention.

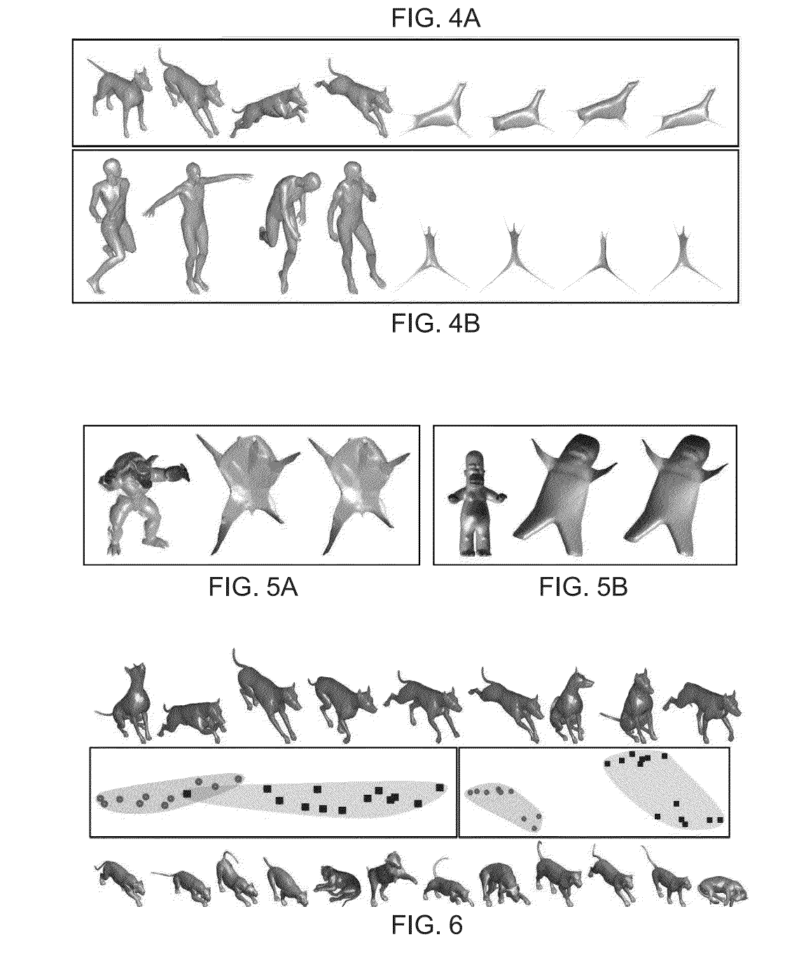

In another experiment, two shapes containing 5,000 vertices were used. For each shape, all pairwise geodesic distances were computed. Then, a subset of 50 vertices was selected using the farthest-point sampling strategy, and 50 eigenvectors of the corresponding LBO were extracted. The surfaces were then flattened into their canonical forms using the dimensionality reduction procedure of the present embodiments. A qualitative evaluation is presented in FIGS. 5A and 5B, which show canonical forms of Armadillo (FIG. 5A) and Homer (FIG. 5B). Within each box is (from left to right) the shape, followed by canonical forms obtained by regular MDS, and spectral MDS. FIGS. 5A and 5B thus demonstrate the similarity of the results of classical scaling on the full matrix, and the dimensionality reduction procedure operating on just 1% of the data.

The relation of within classes and between classes for lionesses and dogs from the TOSCA database [43] is shown in FIG. 6, which shows the dimensionality reduction procedure of the present embodiments compared with MDS with the same number of sampled points (same complexity). Each point in the plane on the central frames represents a shape. The input to the MDS producing the position of the points was distances between the corresponding canonical forms (MDS applied to the result of MDS). Red points represent dogs, and blue points represent lionesses. The dimensionality reduction procedure result (right) provides better clustering and separation between classes compared with the regular MDS (left). Thus, the dimensionality reduction procedure allows considering more points and can thus serve as a better clustering tool.

In an additional experiment, the spectral interpolation of the matrix \tilde{D} was computed for sampled points from Armadillo's surface. The same number of eigenvectors as that of sample points were used. The average geodesic error was plotted as a function of the points used. The mean relative error is computed by mean(|\tilde{D}−D|/∥D+ε∥).

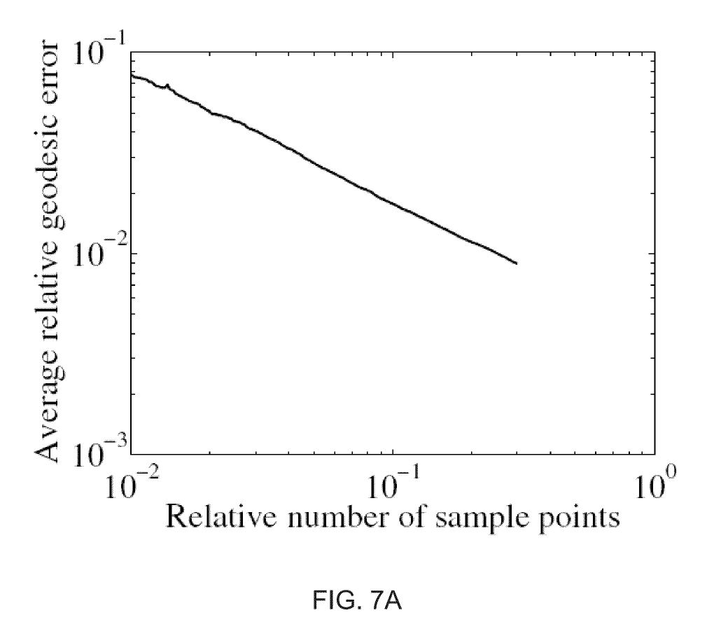

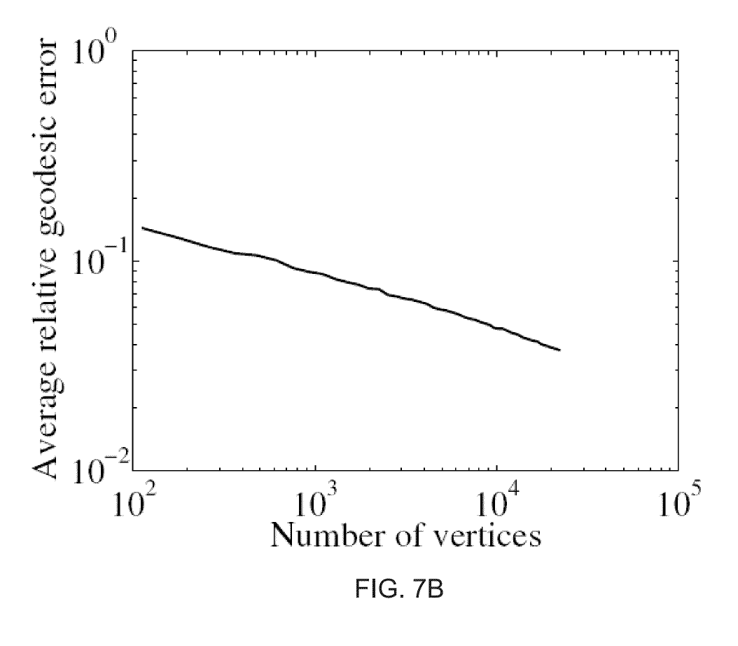

FIG. 7A shows the relative geodesic distortion as a function of the number of sample points for interpolating D. As shown, 5% of the distances between the sample points provide us a distance map that is more than 97% accurate.

In an additional next experiment, the influence of the number of sampled points on the accuracy of the reconstruction was measured. Several triangulations of a sphere were generated, where each triangulation was at a different resolution reflected by the number of triangles. Next, for each such triangulation, the spectral to interpolation of the present embodiments was used for calculating the geodesic distances using just \sqrt{n} points, where n represents the number of vertices of the sphere at a given resolution.

FIG. 7B shows the geodesic error as a function of n. The average error is a decreasing function of the number of points, in the case where \sqrt{n} points are used for the construction.

In an additional experiment, an [symbol] ⁴ manifold embedded in [symbol] ^{10,000}, was extracted. A low-dimensional hyperplane structure from a given set of 100,000 points in [symbol] ^{10,000} was obtained. The dimensionality reduction technique of the present embodiments handles 10⁵ points with very little effort, unlike conventional MDS techniques which are known to have difficulties already with 10⁴ points.

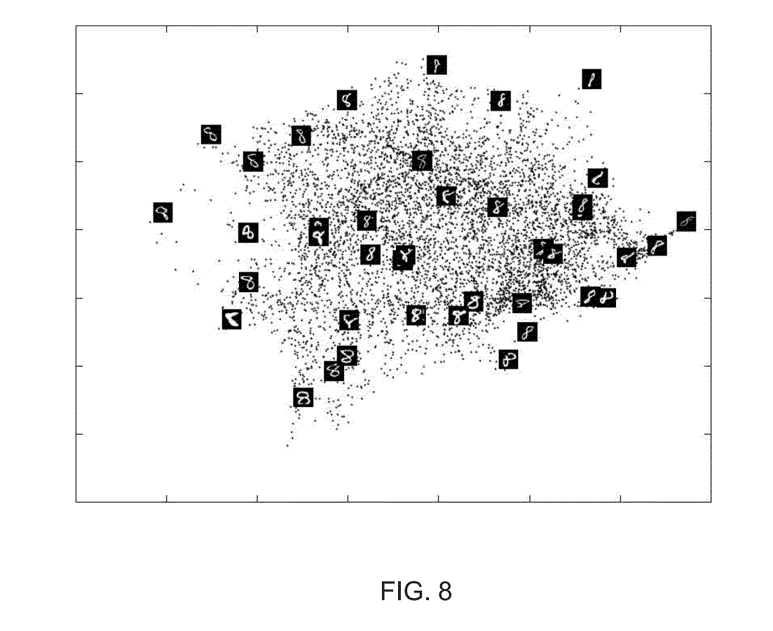

FIG. 8 shows the embedding of 5,851 images of handwritten digit 8 into a plane. The data are taken from the Modified National Institute of Standards and Technology (MNIST) database [42]. A naive metric by which the distance between two images is equal to integration over the pixel-wise differences between them was used. The digits are arranged in the plane such that those on the right tilt to the right, and those on the left slant to the left. Fat digits appear at the bottom, and thin digits at the top.

In an additional experiment, the dimensionality reduction technique of the present embodiments. to a subset of images taken from the MNIST database. Conventional MDS and the dimensionality reduction technique of the present embodiments were computed for 1000, 2000, . . . , 10000 sample of randomly chosen images, referred to as points. 200 eigenvectors of the LBO were evaluated on an i7-Intel® computer with 16 GB memory. Table 1, below, shows the computation times for the conventional and inventive techniques.

TABLE 1

| No. of points | Conventional technique | Inventive technique |
|---|---|---|
| 1000 | 3 | 0.1 |
| 2000 | 5.3 | 0.4 |
| 4000 | 46 | 2.3 |
| 10,000 | 366 | 3.2 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

[1] Schwartz E L, Shaw A, Wolfson E (1989) A numerical solution to the generalized mapmaker's problem: Flattening nonconvex polyhedral surfaces. IEEE Trans PAMI 11(9):1005-1008.
[2] Drury H A, et al. (1996) Computerized mappings of the cerebral cortex: A multiresolution flattening method and a surface-based coordinate system. J Cogn Neurosci 8(1):1-28.
[3] Dale A M, Fischl B, Sereno M I (1999) Cortical surface-based analysis. I. Segmentation and surface reconstruction. Neuroimage 9(2):179-194.
[4] Zigelman G, Kimmel R, Kiryati N (2002) Texture mapping using surface flattening via multidimensional scaling. IEEE Trans Vis Comp Graph 8(2): 198-207.
[5] Grossmann R, Kiryati N, Kimmel R (2002) Computational surface flattening: A voxel-based approach. IEEE Trans PAMI 24(4):433-441.
[6] Elad A, Kimmel R (2003) On bending invariant signatures for surfaces. IEEE Trans PAMI 25(10):1285-1295.
[7] Schweitzer H (2001) Template matching approach to content based image indexing by low dimensional Euclidean embedding. Computer Vision 2001. ICCV 2001: Proceedings of the Eighth International Conference on Computer Vision (IEEE, New York), pp 566-571.
[8] Rubner Y, Tomasi C (2001) Perceptual metrics for image database navigation. PhD dissertation (Stanford Univ, Stanford, Calif.).
[9] Aharon M, Kimmel R (2006) Representation analysis and synthesis of lip images using dimensionality reduction. Int J Comput Vis 67(3):297-312.
[10] Pless R (2003) Image spaces and video trajectories: Using Isomap to explore video sequences. Computer Vision 2003: Proceedings of the Ninth IEEE International Conference on Computer Vision (IEEE, New York), pp 1433-1440.
[11] Bronstein A M, Bronstein M M, Kimmel R (2005) Three-dimensional face recognition. Int J Comput Vis 64(1):5-30.
[12] Borg I, Groenen P (1997) Modern multidimensional scaling: Theory and applications. J Educ Meas 40(3):277-280.
[13] Tenenbaum J B, de Silva V, Langford J C (2000) A global geometric framework for nonlinear dimensionality reduction. Science 290(5500):2319-2323.
[14] Kimmel R, Sethian J A (1998) Computing geodesic paths on manifolds. Proc Natl Acad Sci USA 95(15):8431-8435.
[15] Roweis S T, Saul L K (2000) Nonlinear dimensionality reduction by locally linear embedding. Science 290(5500):2323-2326.
[16] Donoho D L, Grimes C (2003) Hessian eigenmaps: Locally linear embedding techniques for high-dimensional data. Proc Natl Acad Sci USA 100(10):5591-5596.
[17] Belkin M, Niyogi P (2001) Laplacian eigenmaps and spectral techniques for embedding and clustering. Advances in Neural Information Processing Systems (MIT Press, Cambridge, Mass.), pp 585-591.
[18] Coifman R R, Lafon S (2006) Diffusion maps. Appl Comput Harmon Anal 21(1):5-30.
[19] Coifman R R, et al. (2005) Geometric diffusions as a tool for harmonic analysis and structure definition of data: Diffusion maps. Proc Natl Acad Sci USA 102(21):7426-7431.
[20] de Silva V, Tenenbaum J B (2003) Global versus local methods in nonlinear dimensionality reduction. Advances in Neural Information Processing Systems (MIT Press, Cambridge, Mass.), pp 705-712.
[21] Bengio Y, Paiement J F, Vincent P (2003) Out-of-sample extensions for LLE, Isomap, MDS, eigenmaps, and spectral clustering. Advances in Neural Information Processing Systems (MIT Press, Cambridge, Mass.), pp 177-184.
[22] Asano T, et al. (2009) A linear-space algorithm for distance preserving graph embedding. Comput Geom Theory Appl 42(4):289-304.
[23] Bronstein M M, Bronstein A M, Kimmel R, Yavneh I (2006) Multigrid multidimensional scaling. Numer Linear Algebra App 13(2-3):149-171.
[24] Rosman G, Bronstein M M, Bronstein A M, Sidi A, Kimmel R (2008) Fast multidimensional scaling using vector extrapolation. Technical report CIS-2008-01 (Technion, Haifa, Israel).
[25] Rosman G, Bronstein M M, Bronstein A M, Kimmel R (2010) Nonlinear dimensionality reduction by topologically constrained isometric embedding. Int J Comput Vis 89(1):56-68.
[26] Rustamov R M (2011) Interpolated eigenfunctions for volumetric shape processing. Vis Comput 27(11):951-961.
[27] Raviv D, Bronstein M M, Bronstein A M, Kimmel R (2010) Volumetric heat kernel signatures. Proc ACM Workshop 3D Object Retrieval (ACM, New York), pp 39-44.
[28] Williams C K I (2001) On a connection between kernel PCA and metric multidimensional scaling. Advances in Neural Information Processing Systems (MIT Press, Cambridge, Mass.), pp 675-681.
[29] Brard P, Besson G, Gallot S (1994) Embedding Riemannian manifolds by their heat kernel. Geom Funct Anal 4(4):373-398.
[30] Sun J, Ovsjanikov M, Guibas L (2009) A concise and provably informative multi-scale signature based on heat diffusion. Comp Graph Forum 28(5):1383-1392.
[31] Ovsjanikov M, Ben-Chen M, Solomon J, Butscher A, Guibas L (2012) Functional maps: A flexible representation of maps between shapes. ACM Trans Graph 3:30:1-30:11.
[32] Weyl H (1950) Ramifications, old and new, of the eigenvalue problem. Bull Am Math Soc 56(2):115-139.
[33] Pinkall U, Polthier K (1993) Computing discrete minimal surfaces and their conjugates. Exper Math 2(1):15-36.
[34] Aflalo Y, Bronstein A M, Bronstein M M, Kimmel R (2012) Deformable shape retrieval by learning diffusion kernels. Proc Scale Space Variational Meth Comp Vis (Springer, Berlin), Vol 6667, pp 689-700.
[35] Pokrass J, Bronstein A M, Bronstein M M, Sprechmann P, Sapiro G, Sparse modeling of intrinsic correspondences, Computer Graphics Forum (2013) 32:459-468.
[36] Kovnatsky A, Bronstein, M M, Bronstein, A M, Glashoff K, Kimmel R, Coupled quasiharmonic basis, Computer Graphics Forum, (2013) 32:439-448.
[37] Dubrovina A, Kimmel R, Matching shapes by eigendecomposition of the Laplace-Beltrami operator, Proc. of 3DPV, (2010).
[38] Dubrovina A, Kimmel R, Approximately isometric shape correspondence by matching pointwise spectral features and global geodesic structures., Advances in Adaptive Data Analysis, (2012) 3:203-228.
[39] Dyn N, Interpolation and approximation by radial and related functions, Approximation Theory VI, (1989) pp 211-234.
[40] Jonas A, Kiryati N, Length estimation in 3D using cube quantization, Proc. PIE Vision Geometry III vol. 8, (1998), pp 215-238.
[41] Kiryati N, Kilbler O, Chain code probabilities and optimal length estimators for digitized three dimensional curves., Pattern Rec, (1995), 28:361-372.
[42] LeCun Y, Bottou L, Bengio Y, Haffner P, Gradient based learning applied to document recognition Proc. of the IEEE (1998), 86(11):2278-2324.
[43] Bronstein A M, Bronstein M M, Kimmel R (2008) Numerical Geometry of Non-Rigid Shapes (Springer, N.Y.).

What is claimed is:

1. A method of reducing a dimensionality of a dataset, the method comprising:
using a data processor for calculating an interpolation matrix based on a Laplacian eigenbasis matrix of a sparse representation of the dataset, and for applying multidimensional scaling (MDS) to a transformation matrix of said interpolation matrix, thereby providing a reduced dataset; and
storing said reduced dataset is a computer readable medium.

2. The method of claim 1, further comprising obtaining a kernel function for defining diffusion distances over said sparse representation, wherein said calculation of said interpolation matrix is based on said kernel function but not on said diffusion distances.

3. The method of claim 1, wherein said sparse representation of the dataset is characterized by a dissimilarity matrix, and wherein said calculation of said interpolation matrix is also based on said dissimilarity matrix.

4. The method of claim 3, further comprising calculating said dissimilarity matrix.

5. The method according to claim 4, further comprising selecting a subset of elements from the dataset, thereby providing said sparse representation.

6. The method of claim 5, wherein said selecting said subset is by a farthest-point sampling procedure.

7. The method according to claim 5, further comprising calculating said Laplacian eigenbasis matrix.

8. The method of claim 5, wherein said calculating said dissimilarity matrix comprises calculating a dissimilarity measure between every two elements of said selected subset.

9. The method of claim 8, wherein said dissimilarity measure comprises a geodesic distance over a manifold defined by the dataset.

10. The method according to claim 3, wherein said calculating said interpolation matrix comprises applying an optimization procedure to traces of matrices obtained by transformations of an eigenvalue matrix of said Laplacian eigenbasis by said interpolation matrix.

11. The method according to claim 3, wherein said calculating said interpolation matrix comprises transforming a matrix describing said sparse representation using a matrix constructed from said Laplacian eigenbasis matrix, from an eigenvalue matrix of said Laplacian eigenbasis, and from a projection matrix describing a projection of the dataset on said sparse representation.

12. The method according to claim 1, wherein said transformation matrix of said interpolation matrix is a matrix defined as a transformation of said interpolation matrix using said Laplacian eigenbasis matrix.

13. The method according to claim 1, wherein said MDS is effected by a singular value decomposition procedure followed by an eigen decomposition procedure.

14. The method according to claim 1, wherein the dataset comprises at least one type of data selected from the group consisting of: coordinates describing a plurality of objects, images of handwritten characters or symbols, biometric data, audio data, video data, biological data, chemical data, data describing signals acquired by a medical device, meteorological data, seismic data, hyperspectral data, financial data, marketing data and textual corpus.

15. A computer software product, comprising a computer-readable medium in which program instructions are stored, which instructions, when read by a data processor, cause the data processor to access a dataset execute the method according to claim 1.

16. A system of reducing a dimensionality of a dataset, the system comprising a data processor configured for accessing the dataset, calculating an interpolation matrix based on a Laplacian eigenbasis matrix of a sparse representation of the dataset, and applying multidimensional scaling (MDS) to a transformation matrix of said interpolation matrix.

17. The system of claim 16, wherein said data processor is configured for receiving a kernel function for defining diffusion distances over said sparse representation, wherein said calculation of said interpolation matrix is based on said kernel function but not on said diffusion distances.

18. The system of claim 16, wherein said sparse representation of the dataset is characterized by a dissimilarity matrix, and wherein said data processor is configured for calculating said interpolation matrix also based on said dissimilarity matrix.

19. The system of claim 18, wherein said data processor is configured for calculating said dissimilarity matrix.

20. The system according to claim 19, wherein said data processor is configured for selecting a subset of elements from the dataset, thereby providing said sparse representation.

21. The system of claim 20, wherein said data processor is configured for selecting said subset by employing a farthest-point sampling procedure.

22. The system according to claim 20, wherein said data processor is configured for calculating said Laplacian eigenbasis matrix.

23. The system of claim 20, wherein said data processor is configured for calculating said dissimilarity matrix comprises by calculating a dissimilarity measure between every two elements of said selected subset.

24. The system of claim 23, wherein said dissimilarity measure comprises a geodesic distance over a manifold defined by the dataset.

25. The system according to claim 18, wherein said data processor is configured for calculating said interpolation matrix by applying an optimization procedure to traces of matrices obtained by transformations of an eigenvalue matrix of said Laplacian eigenbasis by said interpolation matrix.

26. The system according to claim 18, wherein said data processor is configured for calculating said interpolation matrix by transforming a matrix describing said sparse representation using a matrix constructed from said Laplacian eigenbasis matrix, from an eigenvalue matrix of said Laplacian eigenbasis, and from a projection matrix describing a projection of the dataset on said sparse representation.

27. The system according to claim 16, wherein said transformation matrix of said interpolation matrix is a matrix defined as a transformation of said interpolation matrix using said Laplacian eigenbasis matrix.

28. The system according to claim 16, wherein said MDS is effected by a singular value decomposition procedure followed by an eigen decomposition procedure.
